(19) United States
(12) Patent Application Publication
(10) Pub. No.: US 2020/0157310 A1
(43) Pub. Date: May 21, 2020

(54) DEGRADABLE SYNTHETIC FIBER COMPOSITION AND MANUFACTURING METHOD AND PRODUCT THEREOF

(71) Applicant: THE HONG KONG RESEARCH INSTITUTE OF TEXTILES AND APPAREL LIMITED, Hung Hom (CN)

(72) Inventors: Chi Chung LAM, Hong Kong (CN); Hao WU, Hong Kong (CN)

(73) Assignee: THE HONG KONG RESEARCH INSTITUTE OF TEXTILES AND APPAREL LIMITED, Hung Hom (CN)

(21) Appl. No.: 16/655,531

(22) Filed: Oct. 17, 2019

Related U.S. Application Data
(63) Continuation of application No. 15/558,179, filed on Sep. 13, 2017, now abandoned.

(30) Foreign Application Priority Data
Mar. 13, 2015 (CN) 2015-10111543.5

(51) Int. Cl. C08K 5/098; D01F 1/10; C08L 77/06; C08L 67/02; C08L 77/00; D01F 6/22

(52) U.S. Cl. CPC C08K 5/098; D01F 1/10; C08L 77/06; C08K 3/30; C08L 77/00; D01F 6/22; C08L 67/02

(57) ABSTRACT

The present invention relates to a degradable synthetic fiber composition, a manufacturing method thereof, and a degradable synthetic fiber product manufactured therefrom; wherein the degradable synthetic fiber composition comprises a polymer and two or more transition metal salts dispersed in the polymer; at least one of the two or more transition metal salts is a polyvalent metal salt. The present invention may degrade polymer such as polyester, polyamide, and polystyrene, two or more transition metal additives are selected to produce a synergistic effect, thereby directly improving the utilization of ultraviolet light and visible light; the present invention is the first application of oxidative-biodegradation to synthetic fiber, and can be commercially produced by existing equipment; the formulations and methods of the present invention particularly can be applied directly in weaving techniques such as nonwovens, to further reduce the environmental pollution caused by waste.

### FIELD OF THE INVENTION

The present invention relates to a synthetic fiber composition which can be oxidative-biodegraded in the environment, a manufacturing method thereof, and a degradable synthetic fiber product manufactured therefrom.

### BACKGROUND OF THE INVENTION

Today, the problem of disposal of synthetic polymers such as plastics, synthetic fibers and the like becomes more and more serious, because their degradation in nature takes a long time.

Recently, disposable plastic products such as disposable hygienic, medical supplies and the like gradually have been produced using degradable materials to reduce landfill loads and extend the landfill's period of use. Aliphatic polyesters and starch or plant fibers can be eventually decomposed by microorganisms into non-humus substances such as CO₂ and methanol. However, plant-based polymers are generally hydrophilic compared to petroleum-based polymers, so their mechanical and thermal properties differ considerably; in addition, despite the low price of starch, the production yield of starch and starch/synthetic polymer mixed plastic is relatively low, thus it is more expensive than non-renewable products. Therefore, the development of non-plant-based degradable polymer materials has considerable commercial value.

In addition to bio-degradation, synthetic polymers also undergo oxo-degradation in the nature, i.e., autoxidation. In a free radical chain reaction between an organic polymer and oxygen molecule generally at ambient temperature, the polymer first reacts with oxygen to form a peroxide, and the peroxide absorbs energy and is further decomposed.

RH (heat, O₂, pressure)→ROOH

ROOH→RO.+.OH

Usually, complete oxo-degradation is a very time-consuming process (e.g., hundreds of years) because the decomposition of the peroxide into free radicals requires a very high energy. The degradable additives that have emerged in the market in recent years have been able to accelerate polymer degradation by accelerating the autoxidation process. The prior art has disclosed a degradable resin composition containing a photosensitizer, a degradation promoting agent, a modifier, a biodegradation initiator, a plasticizer, water, a self-oxidant, a free radical initiator, a photoinitiator, a biodegradation promoter, a degradation control agent and a method for producing the same; and a method for improving the biodegradability of hydrated biodegradable polymers by a transition metal salt degradation assisting agent. The main component of such additives is a pro-oxidant containing a transition metal salt. Such transition metal usually has a variable valence state and the valence difference is only ±1, for example Co²⁺/Co³⁺, and they can initiate a free radical chain reaction on a large scale and accelerate the degradation of polyolefins. The detailed mechanism is as follows: the polyolefin RH is oxidized to ROOH under the action of heat and oxygen, under the presence of light, an electron in the metal's (such as Co²⁺) 3d electron layer transfers, and ROOH is converted into carboxylic acid radical (ROO.). And then a decarboxylation reaction converts the polyolefin RH into the radical R′., and R′. is very unstable, with enough energy to crack the long molecular chains into short ones. As a result, a degradation process has occurred. As shown in the following reactions, wherein M represents a transition metal salt and RH represents a polyolefin.

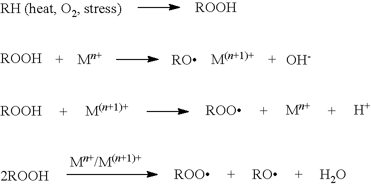

A process for the preparation of oxidative-biodegradable polyolefin plastics using organic metal salts as the chemical degradation agents has also been reported in the prior art. It is developed into a biodegradable additive (P-life) product manufactured by Programmable Life Inc. in Delaware of the U.S., which has been tested and marketed. However, in the normal state, it is difficult for the high valence metal ions (M⁽ⁿ⁺¹⁾⁺) to obtain electrons from the polymer, and the regeneration of low valence metal ions (Mⁿ⁺) is slow, resulting in relative slow free radical producing rate, thereby affecting the degradation of the polymer.

In addition, there is disclosed in the prior art a method for degrading composite plastic by using nano-titanium dioxide to absorb ultraviolet light, and it mainly relates to method for degrading polystyrene, expanded polystyrene, polyvinyl chloride. The reaction mechanism is as follows: when subjected to ultraviolet light with an energy greater than or equal to 3.2 eV, the electrons of the titanium dioxide are excited to produce conduction band electrons (e⁻) with strong reducing power and valence band holes (h⁺) with strong oxidizing power. They react either directly with the surrounding composite polymer or with water molecules and oxygen in a series of reactions to form strongly oxidizing hydroxyl radicals (.OH), superoxide radicals (.O₂⁻), thereby oxidatively decomposing the polymers. In addition, the prior art also discloses a process for the degradation of synthetic polymer compositions using ultraviolet photocatalytic degradation components (nano-TiO₂) and visible light catalytic oxidants (transition metal organic compounds). The product derived therefrom is manufactured by Shandong Xinxin Dazhuang Decomposition Plastic Technology Co., Ltd. and named EBP-PE-M for use in high density polyethylene and linear low density polyethylene plastic bags.

However, ultraviolet light with energy of not less than 3.2 ev only accounts for less than 5% of the total solar energy, while after UV excitation, there is a high energy loss during the hold formation and electron recombination process in titanium dioxide, thus the light utilization rate of TiO₂ is low. Although the application of nano-TiO₂ in degradation technology with respect to film and packaging materials, especially for polypropylene and polyethylene materials, has been very mature, its relatively low quantum effect still fails to obtain enough energy in a limited period of time, thus limiting its degradation effect when used in more complex polymers containing other functional groups.

Polymers such as polyester with desirable high wear resistance and low hygroscopicity have considerable market value and are widely used in the manufacturing process in the textile and garment industry. According to statistics, synthetic fibers can account for half of the world's annual consumption of 45 million fibers. Therefore, the development of degradable fiber plays an important role in reducing the environmental pollution caused by waste disposal. It is also important to apply the idea of accelerating oxidative degradation to degrade polymers having more complex structures.

Another advantage of the use of degradable synthetic polymers in the textile industry is its relatively simple manufacturing process. Synthetic fibers are easy to blend with each other, and their finished products have better mechanical properties. Compared with the method for reducing waste treatment pollution by cellulose fibers or mixed use of natural fibers and synthetic fibers, degradable synthetic fibers have the advantages of having high quality and are inexpensive, easy to maintain as well as being a modern material. Therefore, the development of degradable synthetic fiber also has considerable commercial value and huge room for expansion. Although there has been a slight mention in the prior art that the degradation technique of using a metal-containing organic compound as an oxidizing additive may be applied to other synthetic fibers with more complex structures, such as polyester, polyamide, polystyrene, etc., the test results show that, even with a transition metal organic compound additives (e.g., P-life) that is capable of completely degrading polypropylene and polyethylene, the degradation of the more complex polymers described above is not ideal. This may be due to the fact that functional groups such as carboxyl groups, benzene rings and amides can form stronger bonds in polymers with more complex structures. The breakage of such polymer functional groups requires a higher energy when compared to a simple polyolefin structure with only one long carbon backbone. Therefore, it is necessary to develop a degradable synthetic fiber composition capable of producing a better degradation effect on a polymer, particularly a polymer having a complex structure.

### SUMMARY OF THE INVENTION

The technical problem to be solved by the present invention is, in view of the defect in the prior art that the degradation of a polymer, especially a polymer with complex structure, is poor, the present invention provides an oxidizable-biodegradable synthetic fiber composition which produces a better degradation effect on the polymer, in particular where the polymer has a complex structure, and a manufacturing method and product thereof.

The technical solution for solving the technical problem of the invention is to construct a degradable synthetic fiber composition comprising a polymer and two or more transition metal salts dispersed in the polymer, wherein at least one of the two or more transition metal salts is a polyvalent metal salt.

In the degradable synthetic fiber composition according to the present invention, the polymer is a non-simple and non-linear polymer.

In the degradable synthetic fiber composition according to the present invention, the non-simple and non-linear polymer is a polyester, a polyamide or polystyrene, wherein the polyester is polyethylene terephthalate, polybutylene terephthalate, polypropylene terephthalate fiber, polyethylene naphthalate or a wholly aromatic polyester, the polyamide is an aliphatic polyamide, a polyphthalamide or an aromatic polyamide.

In the degradable synthetic fiber composition according to the present invention, the transition metal in the transition metal salt is selected from the group consisting of vanadium, chromium, manganese, iron, cobalt, nickel, copper, zinc, zirconium, silver, cerium or praseodymium.

In the degradable synthetic fiber composition according to the present invention, the total weight of the metal ions of the two or more transition metal salts is 0.001 to 10.0% of the weight of the degradable synthetic fiber composition. Preferably, the total weight of the metal ions of the two or more transition metal salts is 0.01 to 5.0% of the weight of the degradable synthetic fiber composition.

In the degradable synthetic fiber composition according to the present invention, the transition metal salt is a transition metal organic salt or a transition metal inorganic salt, wherein the transition metal organic salt is stearate, acetate, octanoate, naphthenate, acetylacetonate or oleate of the transition metal, and the transition metal inorganic salt is sulfate, nitrate or chloride of the transition metal. More preferably, the transition metal salt is an organic salt of iron, copper, cobalt or nickel.

In the degradable synthetic fiber composition according to the present invention, the transition metal salt is preferably an organic salt of nickel when the polymer is polystyrene.

In the degradable synthetic fiber composition according to the present invention, the degradable synthetic fiber composition further comprises an antioxidant, wherein the weight of the antioxidant is 0.001 to 5.0% of the weight of the degradable synthetic fiber composition.

The degradable synthetic fiber composition according to the present invention is manufactured in the form of a polymer masterbatch.

The present invention also provides a method for manufacturing the degradable synthetic fiber composition described above, comprising the steps of: mixing all the raw materials through a twin-screw mixer, extruding a polymer strip in molten state from the head die hole, curing the strip, and cutting into granules after cooling.

The present invention also provides a degradable synthetic fiber product made from the degradable synthetic fiber composition described above.

The following advantageous effects are provided by the degradable synthetic fiber composition, manufacturing method and product thereof of the present invention:

1. The degradable synthetic polymer composition such as polyester or polyamide of the present invention with two or more transition metals selected for producing a synergistic effect, thereby directly improving the utilization of ultraviolet light and visible light;

2. The degradable polystyrene composition of the present invention achieves a significant degradation effect;

3. The molecular weight of the polymer of the present invention after degradation is determined by gel permeation chromatography, and the result can be observed more directly and is more reliable; and

4. The present invention is the first application of oxidative-biodegradation to synthetic fiber, and can be commercially produced by existing equipment, especially in weaving techniques such as nonwovens. The formulations and methods of the present invention can also be further applied directly in the recycling process of non-degradable polymers, especially polyesters, to further reduce the environmental pollution caused by waste.

### BRIEF DESCRIPTION OF THE DRAWINGS

The invention will now be described in further detail with reference to the accompanying drawings and examples, in the accompanying drawings:

FIG. 1 is a degradation mechanism diagram of two different transition metals according to the present invention;

FIG. 2 is a sample of a fibrous material made from the degradable synthetic fiber composition according to the present invention;

FIG. 3 is a sample of another fibrous material made from the degradable synthetic fiber composition according to the present invention;

FIG. 4 is a nonwoven fabric made of a degradable synthetic fiber composition;

FIG. 5 shows the degradable synthetic fiber composition of Comparative Example 1 before UV treatment;

FIG. 6 shows the degradable synthetic fiber composition of Comparative Example 1 after UV treatment;

FIG. 7 is a gel permeation chromatogram of the degradable synthetic fiber composition of Comparative Example 1 before and after UV treatment;

FIG. 8 is a gel permeation chromatogram of the degradable synthetic fiber composition of Example 1 before and after UV treatment;

FIG. 9 is a gel permeation chromatogram of the degradable synthetic fiber composition of Comparative Example 2 before and after UV treatment;

FIG. 10 is a gel permeation chromatogram of the degradable synthetic fiber composition of Example 2 before and after UV treatment.

### DETAILED DESCRIPTION OF THE INVENTION

The present invention will be described in further detail with reference to the accompanying drawings and examples to illustrate more clearly the objects, technical solutions and advantages of the present invention.

The present invention provides a degradable synthetic fiber composition which may be provided in the form of a polymer masterbatch. The degradable synthetic fiber composition comprises synthetic fibers and transition metal ions. When disposed into the environment, the product of this composition accelerates the degradation of polymer wastes such as polyesters, polyamides and polystyrenes by chelating techniques.

The present invention provides a degradable synthetic fiber composition comprising a polymer and two or more transition metal salts dispersed in the polymer, wherein at least one of the two or more transition metal salts is a polyvalent metal salt.

The polymer used in the present invention may be a conventional polymer such as polypropylene, polyethylene, polyester, polyamide or polystyrene, and particularly a polymer having a relatively complicated structure. Such polymer having a relatively complicated structure refers not only to polymers having a simple long chain structure but also polymers, such as polyester, polyamide or polystyrene, having complex functional groups such as carboxyl groups, benzene rings and amides capable of forming stronger bonding. Polyester refers to a copolymer of a polyester resin which is composed of a terephthalate group such as polyethylene terephthalate (PET), polybutylene terephthalate (PBT), polytrimethylene terephthalate fiber (PTT), polyethylene naphthalate (PEN) or wholly aromatic polyester (Vectran). The polyamide is aliphatic polyamide such as PA 6, PA66 and PA 6T, polyphthalamide or aromatic polyamide (Aramides), i.e., p-phenylenediamine and terephthalic acid polymers. These polymers require more energy to be degrade due to the presence of functional groups forming stronger bonds, so that existing commercial products or single metal organic compound products cannot assist or can only assist slightly in the decomposition.

Two or more transition metal salts are used in the degradable synthetic fiber compositions of the present invention. The two or more transition metal salts may be organic or inorganic salts of any transition metal, wherein at least one of the metal salts is a polyvalent transition metal, preferably an organic salt of a polyvalent transition metal. This is because after several experiments and concluding from the experience, the present inventors found that one of the metal salts must be a polyvalent transition metal salt and that the metal salts cannot be all monovalent metal salts. Otherwise, degradation of the degradable synthetic fiber composition will be affected. More preferably, the transition metal salt is an organic salt of a multivalent transition metal in which the electron transfer in the metal occurs in the 3d shell layer or the 4f shell layer as defined in the periodic table. They are elements having atomic numbers of 21 to 30 in the fourth row, elements having atomic numbers of 39 to 48 in the fifth row, and elements having atomic numbers of 57 to 71 in the sixth row. In these particular transition metals, the metals in which electron transfer occurs in the 3d shell layer are vanadium, chromium, manganese, iron, cobalt, nickel, copper, zinc, zirconium and silver in the fourth and fifth rows, and the metal in which electron transfer occurs at the 4f shell layer is cerium or praseodymium in the sixth row.

The novel technology of using the two or more transition metal salts developed in the present invention is called a multi-metal catalytic degradation technique. In this technique, for the purpose of degradation, the two or more different transition metal salts assists with the degradation, and with excitation by the photons, the electron of the metal in 3d or 4f electron layer is transferred to the polymer to produce free radicals which, through synergistic action, induce degradation of polymers such as polyesters, polyamides and the like.

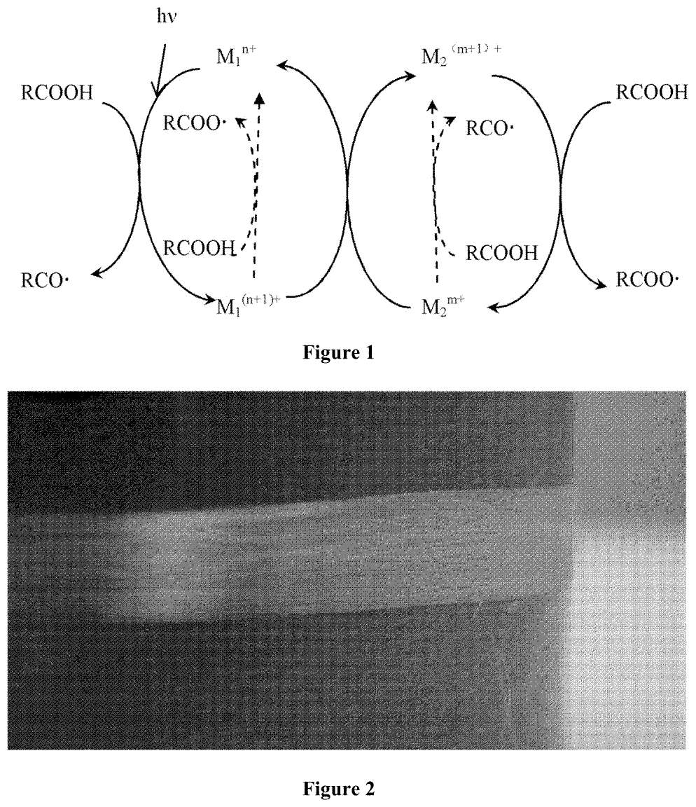

Although the mechanism of accelerated free radical chain degradation by synergistic effects of transition metals is not yet fully understood, it is different from that existing in the field of degradation of chlorine-containing compounds and treatment of dye wastewater, wherein the degradation reaction is initiated by the transition metal ions with a higher valence state (Fe³⁺), and the degradation reaction follows a single electron transfer mechanism. Instead it may be initiated by a single electron transfer in the 3d or 4f electron layer of the transition metal ions with a lower valence state (e.g., Fe²⁺), and the basic process may be represented by FIG. 1.

M₁ and M₂ are two different transition metals. The valence of M₁ is usually n+/n+1; the valence of M₂ is usually m+/m+1; under normal circumstances, the reducing power of M₁>M₂, the reducing power of ion M₂^{m+}>M₁ⁿ⁺, and the redox potential difference (ΔE) of the metal ion M₂^{(m+1)+}/M₂^{m+} is less than that of M₁⁽ⁿ⁺¹⁾⁺/M₁ⁿ⁺. According to the mechanism of single electron transfer initiating free radical chain, upon photoexcitation, the electrons are first transferred from 3d or 4f electron layer of the metal M₁ to the polymer, and the metal is oxidized to M₁⁽ⁿ⁺¹⁾⁺; then, M₁⁽ⁿ⁺¹⁾⁺ is reduced by the second metal ion M₂^{m+} to regenerate M₁ⁿ⁺; and M₂^{m+1} can also obtain an electron from the polymer and be reduced to M₂^{m|}. The different valence ions of the two metals complete the cycle, thereby continuously introducing free radicals into the polymer until the oxidative decomposition is complete.

ROOH+M₁ⁿ⁺→RO.+M₁⁽ⁿ⁺¹⁾⁺+OH⁻

M₂^{m+}+M₁⁽ⁿ⁺¹⁾⁺→M₂^{(m+1)+}+M₁ⁿ⁺

ROOH+M₂^{m+1}→ROO+M₂^{m+}+H⁺

2ROOH→ROO.+RO.+H₂O

Since the oxidation-reduction potential difference (ΔE) of the metal ion M₂^{(m+1)+}/M₂^{m+} is less than that of M₁⁽ⁿ⁺¹⁾⁺/M₁ⁿ⁺, M₂^{(m+1)+}/M₂^{m+} is more prone to redox process, and the ion cycle is completed faster, the rate of reacting with the polymer to regenerate M₂^{m+} upon illumination is greater than that of single metal cycle M₁⁽ⁿ⁺¹⁾⁺/M₁ⁿ⁺; meanwhile, the reducing power of M₂^{m+} is far greater than the polymer molecules, thus M₂^{m+} can reduce M₁⁽ⁿ⁺¹⁾⁺ more quickly. Therefore, under the synergistic effect of the two metals, the utilization of light energy is significantly improved, and the generation rate of free radicals and the production are increased, thus enough energy can be obtained in a relatively short period of time to degrade non-simple and non-linear polymers containing functional groups.

In the preferred embodiment of the present invention, the total weight of the metal ions of the two or more transition metal salts is 0.001 to 10.0%, more preferably 0.01 to 5.0%, of the weight of the degradable synthetic fiber composition.

Preferably, the transition metal salt used in the present invention is a transition metal organic or inorganic salt. Preferably, the transition metal organic salt is a transition metal stearate, acetate, octanoate, naphthenate, acetylacetonate or oleate, such as manganese stearate, silver stearate, cobalt stearate, iron stearate, copper stearate, lead stearate, cerium stearate, manganese oleate, silver oleate, cobalt oleate, copper oleate, zinc oleate, iron oleate, cobalt naphthenate, iron naphthenate, or zinc naphthenate and the like. The transition metal inorganic salt is a transition metal sulfate, nitrate or chloride such as iron sulfate, copper sulfate, zinc chloride, copper nitrate, cobalt chloride, nickel sulfate or zinc sulfate and the like.

Experiments show that when the transition metal salt is a transition metal organic salt, the degradation of the degradable synthetic fiber composition is better. More preferably, when the transition metal salt is an organic salt of iron, copper, cobalt or nickel, the degradation effect of the degradable synthetic fiber composition is the best.

It has also been found in the present invention that a specific transition metal salt has a significant degradation effect on polystyrene. Preferably, the specific transition metal salt is an organic salt of nickel, such as nickel stearate, nickel oleate, nickel naphthenate and the like. Even if only one transition metal salt, such as a nickel-containing organic salts, is used, it can also produce a good degradation effect on polystyrene.

In the degradable synthetic fiber compositions of the present invention, an appropriate amount of an antioxidant may be added, but not necessarily, to control the degradation time of the degradable polymer. The amount of antioxidant depends on the actual use of the finished product, and may generally be from 0.001 to about 5.0 weight percent, based on the total weight of the total polymer composition. By carefully controlling the appropriate weight percent of the transition metal ions and antioxidants in the polymer, degradation over a specified period of time, i.e., a few years or less, may be achieved. The antioxidant in the present invention is not limited to any particular chemical and may be any substance capable of slowing or preventing oxidation. Commercially available antioxidant products are used in the present invention, for example: IRGANOX® 1010, TINUVIN® P, IRGANOX® 1098, uvinul® 3008, Tinuvin 320, IRGAFOS® 168, Sovchem AO1010, Sovchem AO1076, Sovchem AO1330, Sovchem AO245, Sovchem AO3114, Sovchem MD1024, Sovchem AO1098, Sovchem B215, Sovchem B220, Sovchem B561, Sovchem B900, Sovchem B921, Sovchem B225, Sovchem AO168, Sovchem AO-TBM6, and the like.

The present invention also provides a method for manufacturing the above-mentioned degradable synthetic fiber composition, comprising the following steps: all the raw materials including the polymer, such as polyester, polyamide or polystyrene and the like, are mixed with the transition metal salt through a twin-screw mixer, and the polymer strip in molten state is extruded from the head die hole, then the strip is cured and cut into granules after cooling. Antioxidants, transition metal salts can be mixed with the polymer according to actual needs.

In particular, the degradable masterbatch of the degradable synthetic fiber composition of the present invention is prepared by a mixer having a twin-screw with a constant speed of 50 to 500 rpm, preferably 100 to 280 rpm. The target polymer resin and suitable amount of an oxidation promoting agent of one or at least two multivalent transition metal salt powders, are fed to a feeder monitored by a feed system. After mixing, the polymer strip, which is still in molten state, is extruded from the head die hole. The strip is cured and cooled by passing a water tank and then cut into granules, and the degradable masterbatch of the present invention is prepared.

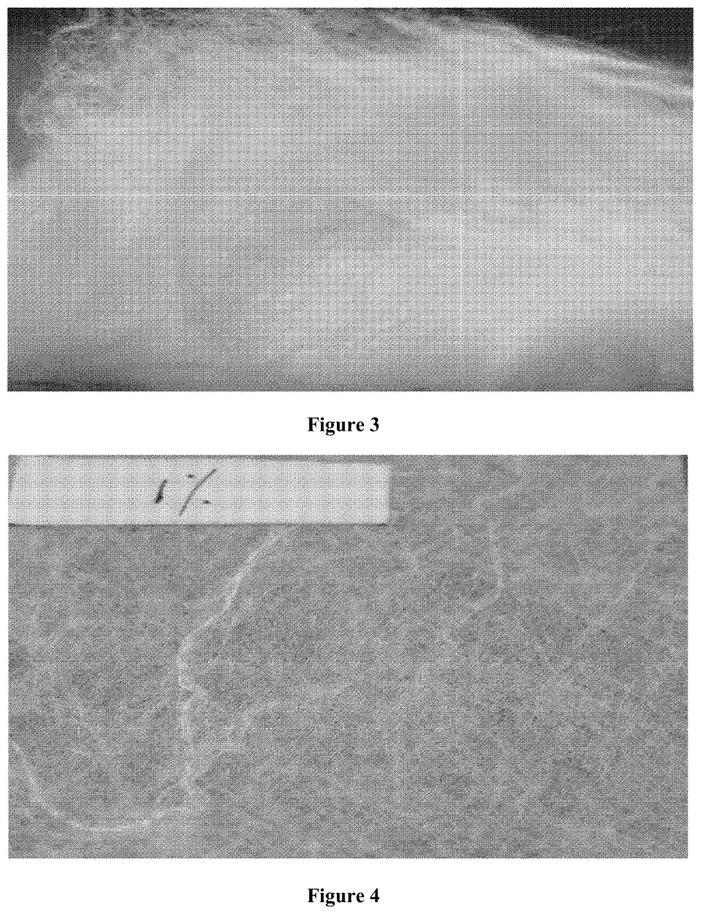

The present invention also provides a degradable synthetic fiber product made from the degradable synthetic fiber composition as described above. For example, a degradable masterbatch obtained by the preparation using the above degradable synthetic fiber composition is used as a raw material for the industrial production of synthetic fibers or more advanced synthetic fiber product. The degradable masterbatch can be directly added in the polymer filament production process to prepare the degradable synthetic fiber product. The multiple metal ion oxidation technique employed in the present invention is new and is applied for the first time in the textile industry. The manufacture of the fiber and the nonwoven fabric of the present invention is carried out by the laboratory of the Clothing Training Board, Institute of Textiles and Clothing of the Hong Kong Polytechnic University. The finished products are shown in FIGS. 2 to 4. FIGS. 2 and 3 depict fibrous materials made from the degradable synthetic fiber compositions of the present invention. FIG. 4 depicts a nonwoven material made of a degradable synthetic fiber composition.

In order to evaluate the degradability of the finished products, about 0.05 to 20 g of granules from the masterbatch, most preferably about 0.1 to 5 g, is completely dissolved in a suitable solvent, heated for 5 to 80 minutes, most preferably 10 to 30 minutes, and then slowly dropped onto a foil, and air-dried to form a film of the degradable synthetic fiber composition. Alternatively, about 0.5 to 20 g of granules from the masterbatch, most preferably about 1 to 5 g, is heated for 5 to 80 minutes, most preferably 10 to 30 minutes by a hot extruder at a temperature of 120 to 350° C., most preferably 180 to 260° C., and then applied to the corresponding extruding plate to form a film of the degradable synthetic fiber composition.

Subsequently, the film is subjected to UV treatment for 5 to 60 days, most preferably from 10 to 30 days, depending on the type of the subject polymer and the weight percentage of the added transition metal. During this period, about 0.1 to 5 mg, most preferably 1 to 2 mg of the UV-treated sample is taken out to examine structural changes by gel permeation chromatography. The time required to change its structure indicates the degradation effect of the degradation promoting agents (i.e., transition metal ions). A shorter time indicates that the transition metal ions have better degradation promoting effect. The degradation of the sample is also determined by international methods, such as the use of ASTM D6954 to study the weight average molecular weight (M_{w}) of the polymer.

For the purpose of further illustrating the present invention, the following specific examples are set forth.

### COMPARATIVE EXAMPLE 1

100 g of polystyrene was added to a twin-screw mixer together with a commercially available oxidation additive (5 g of P-life), and after mixing, the polymer strips in molten state were extruded from the head die hole, then the strips were cured and cut into granules after cooling, wherein the speed of the twin-screw mixer was 100 to 280 rpm.

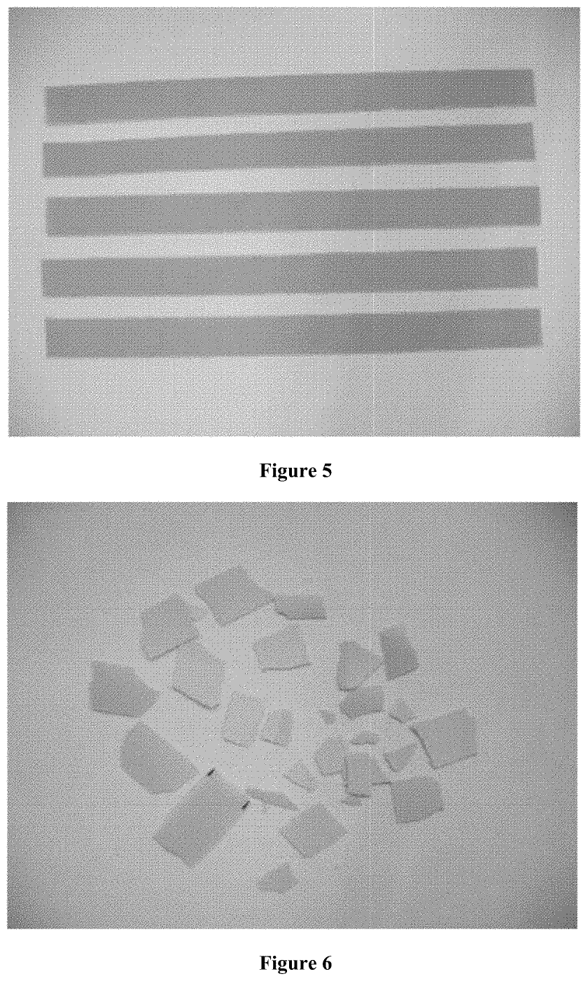

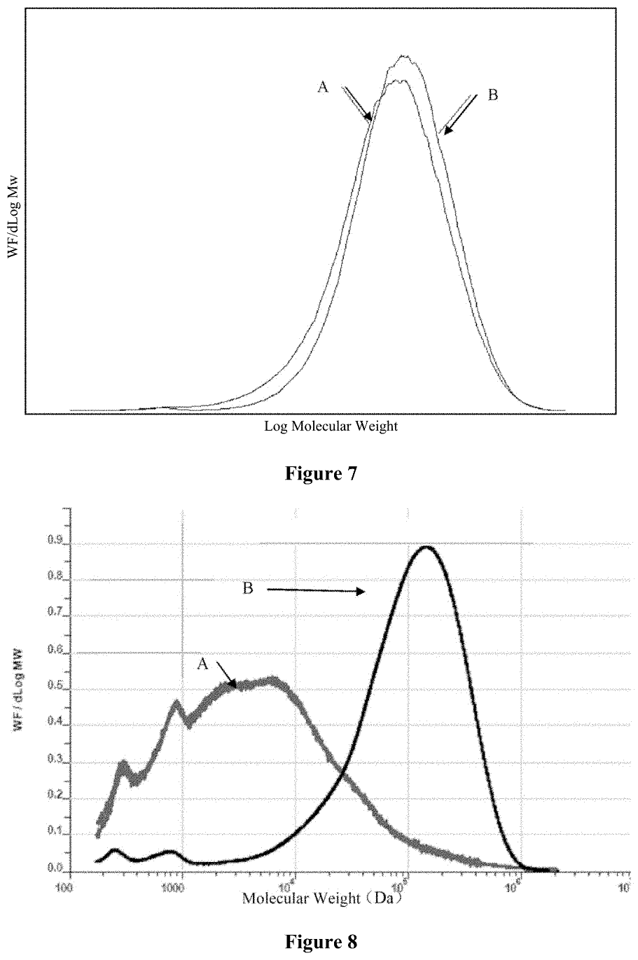

A film of the degradable synthetic fiber composition was prepared by the aforementioned method, and the film was subjected to UV treatment for 6 weeks. FIGS. 5 and 6 show the degradable synthetic fiber composition of Comparative Example 1 before and after UV treatment. As shown in the figures, although the polymer was fragmented after 6 weeks of UV treatment, the gel permeation chromatography test showed that the weight average molecular weight (M_{w}) of the degradable synthetic fiber composition in this example was not significantly different after 6 weeks of UV treatment, as shown in FIG. 7, wherein, B is the sample before UV treatment and A is the sample after UV treatment. This indicates that the sample did not degrade or only slightly degraded after exposure to UV light, and ASTM D3826, which uses a tensile test to determine the degradation end point of degradable polymers, is not suitable for such degradable synthetic fiber products.

### EXAMPLE 1

100 g of polystyrene was added to a twin-screw mixer together with a transition metal salt (5 g of nickel stearate), and after mixing, the polymer strips in molten state were extruded from the head die hole, then the strips were cured and cut into granules after cooling, wherein the speed of the twin-screw mixer was 100 to 280 rpm.

A film of the degradable synthetic fiber composition was prepared by the aforementioned method, and the film was subjected to UV treatment for 6 weeks. As shown in FIG. 8, B is the sample before UV treatment and A is the sample after UV treatment. The gel permeation chromatography test showed that the weight average molecular weight (M_{w}) of the degradable synthetic fiber composition in this example was significantly reduced after 6 weeks of UV treatment, indicating that the sample began to degrade after exposure to UV light.

### COMPARATIVE EXAMPLE 2

100 g of polyester (polyethylene terephthalate) was added to a twin-screw mixer together with a commercially available oxidation additive (4 g of P-life), and after mixing, the polymer strips in molten state were extruded from the head die hole, then the strips were cured and cut into granules after cooling, wherein the speed of the twin-screw mixer was 100 to 280 rpm.

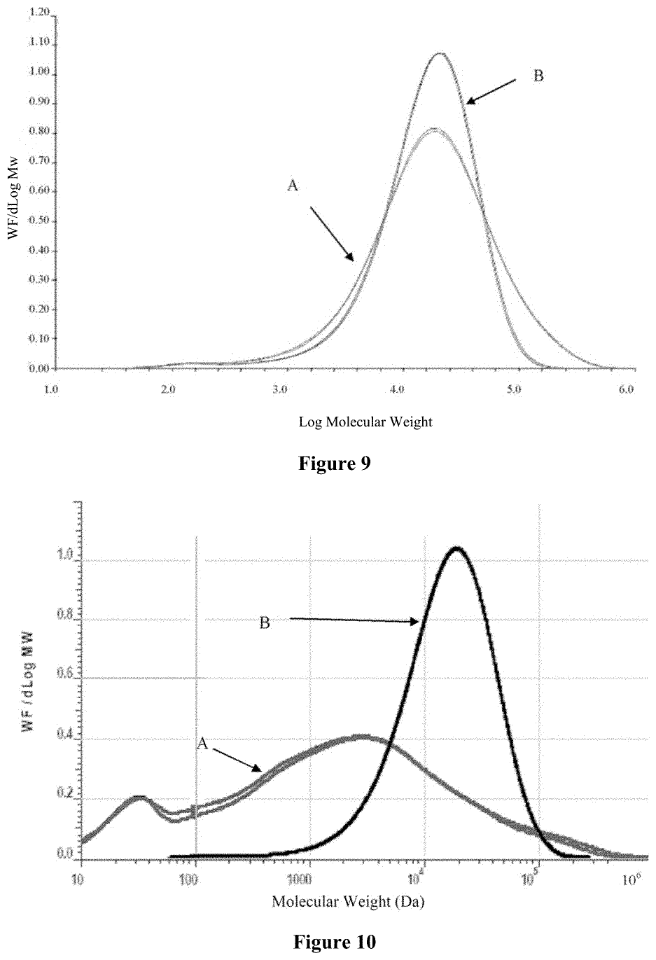

A film of the degradable synthetic fiber composition was prepared by the aforementioned method, and the film was subjected to UV treatment for 6 weeks. As shown in FIG. 9, B is the sample before UV treatment and A is the sample after UV treatment. The gel permeation chromatography test showed that the weight average molecular weight (M_{w}) of the degradable synthetic fiber composition in this example was not significantly different after 6 weeks of UV treatment, indicating that the sample did not degrade or only slightly degraded after exposure to UV light.

### EXAMPLE 2

100 g of polyester (polyethylene terephthalate) was added to a twin-screw mixer together with transition metal salts (3 g of iron stearate and 1 g of copper stearate), and after mixing, the polymer strips in molten state were extruded from the head die hole, then the strips were cured and cut into granules after cooling, wherein the speed of the twin-screw mixer was 100 to 280 rpm.

A film of the degradable synthetic fiber composition was prepared by the aforementioned method, and the film was subjected to UV treatment for 6 weeks. As shown in FIG. 10, B is the sample before UV treatment and A is the sample after UV treatment. The gel permeation chromatography test showed that the weight average molecular weight (M_{w}) of the degradable synthetic fiber composition in this example was significantly reduced after 6 weeks of UV treatment, indicating that the sample began to degrade after exposure to UV light.

The following Table 1 compares the number average molecular weight (Mₙ) and the weight average molecular weight (M_{w}) of polymers containing P-life and polymers mixed with transition metal salt.

TABLE 1

| | | | After UV treatment | |
|---|---|---|---|---|
| | Before UV treatment | | for 6 weeks | |
| | Number | Weight | Number | Weight |
| | average | average | average | average |
| | molecular | molecular | molecular | molecular |
| | weight | weight | weight | weight |
| Samples | Mₙ | M_{w} | Mₙ | M_{w} |
| Comparative Example 2, | 5,490 | 23,200 | 4,740 | 33,700 |
| Polyethylene terephthalate | | | | |
| containing P-life | | | | |
| Example 2, polyethylene | 6,530 | 21,800 | 160 | 11,500 |
| terephthalate containing two | | | | |
| or more transition metal salts | | | | |
| Comparative Example 1, | 49,210 | 121,810 | 40,046 | 108,810 |
| Polystyrene containing P-life | | | | |
| Example 1, polystyrene | 8,860 | 147,000 | 1,350 | 20,300 |
| containing transition metal | | | | |
| salt | | | | |

The initiation of reaction is related to the presence of impurities and defects in the polymer chain. This decomposition may result in the formation of unstable species that will further accelerate the degradation reaction through branched oxidation chain. After prolonged exposure, it was found that the unstable species would be drifting in the more stable secondary oxidation product. As shown in Table 1, the weight average molecular weight (M_{w}) of polymer samples in which one or more transition metal salts were dispersed was significantly decreased after 6 weeks of UV treatment as revealed by gel permeation chromatography, based on the international standard ASTM D6954 study of the weight average molecular weight (M_{w}) of the polymer. This indicates that the sample began to degrade after exposure to UV light. Polymer samples in which commercially available oxidative additives (such as P-life) were dispersed had no significant change in weight average molecular weight (M_{w}), despite the polymer films may have been fragmented (e.g., polystyrene). This indicates that the sample did not degrade after exposure to UV light, and ASTM D3826, which uses the tensile test to determine the degradation end point of the degradable polymer, is not suitable for all degradable synthetic fibers.

Under normal conditions, one of the transition metal salts employed in the present invention has sufficient energy to initiate the degradation process of the polyolefin. However, it can be seen from the experiment that when only one metal salt is applied to complex structural materials such as polyester, it does not produce any effect on the degradation process, as shown in FIGS. 5 to 7. This is due to the large and complex structure of the polyester, so that additional energy is required to break the strong bonds therein to degrade it.

Thus, the multiple transition metal salt formulations disclosed in the present invention significantly contribute to the degradation of complex polymers, and the resulting synergistic effect thereof represents significant progress relative to the commercialized oxidative degradation additives. At the same time, choosing an appropriate transition metal salt in an appropriate amount can result in a satisfactory and reasonable product shelf life. The addition of a low concentration of transition metal ions will provide a decomposable product having the intended shelf life. Conversely, the addition of a high concentration of metal ions will provide a product with short shelf life.

In addition, the use of multiple metal ion salts to develop degradable synthetic fiber compositions is also cost effective. They have a relatively low cost compared to commercial degradable additives and plant-based polymers. Meanwhile, these transition metals do not cause harm to the environment after treatment, and thus the polymer compositions according to the present invention are environmentally friendly.

In accordance with the degradable synthetic fiber composition of the present invention, suitable polyvalent transition metals are selected for use in combination. Suitable organic salts of polyvalent transition metals are typically metal salts of stearic acid, metal salts of acetic acid, metal salts of octanoic acid, metal salts of naphthenic acids or metal salts of acetylacetonate salts, only as an example, such as manganese stearate, silver stearate, cobalt stearate, iron stearate, copper stearate, lead stearate, cerium stearate, manganese oleate, silver oleate, cobalt oleate, copper oleate, zinc oleate, iron oleate, cobalt naphthenate, iron naphthenate, zinc naphthenate and the like, but are not limited to the above salts, other organic groups may be used if desired. In another aspect, the present invention relates to suitable polyvalent transition metal inorganic salts such as iron sulfate, copper sulfate, zinc chloride, copper nitrate, cobalt chloride, nickel sulfate, zinc sulfate and the like.

Accordingly, the present invention also provides a number of examples based on Example 4 in which the polymers are replaced by polyesters, such as polyethylene terephthalate, polybutylene terephthalate, polypropylene terephthalate fiber, polyethylene naphthalate or wholly aromatic polyester; or polyamides such as aliphatic polyamides, polyphthalamide or aromatic polyamides; or polystyrene. The transition metal salts in the degradable synthetic fiber composition is replaced by two or more of the following transition metal salts, and one of them is a polyvalent metal salt: manganese stearate, silver stearate, cobalt stearate, iron stearate, copper stearate, lead stearate, cerium stearate, manganese oleate, silver oleate, cobalt oleate, copper oleate, zinc oleate, iron oleate, cobalt naphthenate, iron naphthenate, zinc naphthenate and the like; or iron sulfate, copper sulfate, zinc chloride, copper nitrate, cobalt chloride, nickel sulfate, zinc sulfate and the like. The total weight of the metal ions of the two or more transition metal salts is from 0.001 to 10.0% by weight of the degradable synthetic fiber composition. Certain examples containing 0.001% to 5.0% of commercially available antioxidant products are also provided. Films of the degradable synthetic fiber compositions were prepared by the method described above from the above-mentioned degradable masterbatch samples, and the films were subjected to UV treatment for 6 weeks. Gel permeation chromatography test showed that the weight average molecular weights (M_{w}) of the degradable synthetic fiber compositions in the examples were significantly reduced after 6 weeks of UV treatment, indicating that the samples began to degrade after exposure to UV light, thus proving that these degradable synthetic fiber compositions have good degradation properties. Some of the typical examples are listed below:

### EXAMPLE 3

1000 g of polystyrene was added to a twin-screw mixer together with transition metal salts (0.1 g of copper stearate and 0.05 g of iron stearate), and after mixing, the polymer strips in molten state were extruded from the head die hole, then the strips were cured and cut into granules after cooling, wherein the speed of the twin-screw mixer was 50 to 200 rpm.

### EXAMPLE 4

1000 g of polystyrene was added to a twin-screw mixer together with transition metal salts (1 g of copper stearate and 0.5 g of nickel stearate), and after mixing, the polymer strips in molten state were extruded from the head die hole, then the strips were cured and cut into granules after cooling, wherein the speed of the twin-screw mixer was 300 to 500 rpm.

### EXAMPLE 5

100 g of polyester (polyethylene naphthalate) was added to a twin-screw mixer together with transition metal salts (1.5 g of iron stearate, 0.5 g of copper oleate and 0.5 g of nickel olate), and after mixing, the polymer strips in molten state were extruded from the head die hole, then the strips were cured and cut into granules after cooling, wherein the speed of the twin-screw mixer was 300 to 500 rpm.

### EXAMPLE 6

100 g of polyester (wholly aromatic polyester) was added to a twin-screw mixer together with transition metal salts (2 g of cobalt stearate and 0.5 g of copper oleate), and after mixing, the polymer strips in molten state were extruded from the head die hole, then the strips were cured and cut into granules after cooling, wherein the speed of the twin-screw mixer was 100 to 280 rpm.

### EXAMPLE 7

100 g of polyamide (aliphatic polyamide) was added to a twin-screw mixer together with transition metal salts (2 g of cerium stearate, 0.5 g of cobalt oleate and 0.05 g of zinc sulfate), and after mixing, the polymer strips in molten state were extruded from the head die hole, then the strips were cured and cut into granules after cooling, wherein the speed of the twin-screw mixer was 100 to 280 rpm.

### EXAMPLE 8

100 g of polyamide (phthalamide) was added to a twin-screw mixer together with transition metal salts (7 g of cobalt naphthenate, 3 g of cerium stearate and 0.5 g of iron sulfate), and after mixing, the polymer strips in molten state were extruded from the head die hole, then the strips were cured and cut into granules after cooling, wherein the speed of the twin-screw mixer was 100 to 280 rpm.

The above-described examples are merely preferred examples for explaining the present invention, and the scope of the present invention is not limited thereto. Equivalents or substitutions made by those skilled in the art on the basis of the present invention are within the scope of the present invention. The scope of the invention is defined by the claims.

1.-13. (canceled)

14. A degradable synthetic fiber composition comprising a polymer and two or more transition metal salts dispersed in the polymer, wherein at least one of the two or more transition metal salts is a polyvalent metal salt selected from nickel stearate, nickel acetate, nickel octanoate, nickel naphthenate, nickel acetylacetonate, or nickel oleate, and wherein the polymer is polystyrene.

15. The degradable synthetic fiber composition of claim 14, wherein the total weight of the metal ions of the two or more transition metal salts is 0.001 to 10.0% of the weight of the degradable synthetic fiber composition.

16. The degradable synthetic fiber composition of claim 15, wherein the total weight of the metal ions of the two or more transition metal salts is 0.01 to 5.0% of the weight of the degradable synthetic fiber composition.

17. The degradable synthetic fiber composition of claim 14 further comprising an antioxidant, wherein the weight of the antioxidant is 0.001 to 5.0% of the weight of the degradable synthetic fiber composition.

18. The degradable synthetic fiber composition of claim 14, wherein the degradable synthetic fiber composition is manufactured in the form of a polymer masterbatch.

19. A method for manufacturing the degradable synthetic fiber composition of claim 1, the method comprising: mixing the polymer and the two or more transition metal salts through a twin-screw mixer, extruding a polymer strip in molten state from the head die hole, curing the strip, and cutting into granules after cooling.

20. A degradable synthetic fiber product made from the degradable synthetic fiber composition of claim 14, wherein the degradable synthetic fiber product is in the form of a fibrous material or nonwoven material.
